(19) United States
(12) Patent Application Publication
(10) Pub. No.: US 2007/0111729 A1
(43) Pub. Date: May 17, 2007

(54) Network support for mobility system capacity planning using real-time snapshot across networked mobile switching centers for roaming mobile terminals

(76) Inventors: Narayan A. Kulkarni, Wheaton, IL (US); Baoling S. Sheen, Naperville, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/274,992

(22) Filed: Nov. 16, 2005

(51) Int. Cl. H04Q 7/20

(52) U.S. Cl. 455/435.1

(57) ABSTRACT

An apparatus in one example has: a telecommunications network having a plurality of mobile switching centers each of the mobile switching centers having a respective visitor location register; a selected at least one mobile switching center of the plurality of mobile switching centers; periodic time intervals; and a respective set of recordings of numbers of current entries in the respective visitor location registers measured at the same designated time of the selected at least one mobile switching center existing at an end of each of the time intervals.

### TECHNICAL FIELD

The invention relates generally to telecommunication networks, and more particularly to a telecommunications network that supports a mechanism for estimating the number of subscribers that are eligible to receive service in the mobility system for capacity planning and resource engineering.

### BACKGROUND

Wireless and wired communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA).

Wireless service providers are always trying to optimize resource engineering and capacity planning by using various ways to estimate system loading at different times of the day. However, due to mobility of subscribers, conventional methods of estimating traffic per call (Erlangs/call) are not applicable in mobile systems. The trending data from the past can in a sense be a predication, but is not accurate, Also, retrieving the number of users from a visitor location register (VLR) only gives static information, which doesn't reflect the possible usage difference and system loading during different hours of the day.

In landline telephony, system loading is calculated based on hourly traffic measurements and the number of static subscribers in the system. However, in mobile systems there is no known method for estimating this important engineering and capacity planning parameter. There is a need for an accurate method of estimating subscriber traffic across a mobile network. Mobile networks are very capital intensive. Hence optimal engineering is necessary to provide economical mobile service. Thus, there is a significant need to provide the necessary data to engineer and plan mobile networks economically. This has very significant impact on service provider revenues and improves profitability of the business.

Thus there is a need in the art for a system that provides a mechanism to more accurately predict the system loading and thus help service providers to allocate the resources more efficiently based on dynamic real-time subscriber data.

### SUMMARY

One implementation encompasses an apparatus. This apparatus may comprise: a telecommunications network having a plurality of mobile switching centers each of the mobile switching centers having a respective visitor location register; a selected at least one mobile switching center of the plurality of mobile switching centers; periodic time intervals; and a respective set of recordings of numbers of current entries in the respective visitor location registers of the selected at least one mobile switching center existing at an end of each of the time intervals.

One implementation encompasses a method. This embodiment of the method may comprise: selecting at least one mobile switching center from a plurality of mobile switching centers; checking visitor location registers of the selected at least one mobile switching center for current mobile terminals at periodic time intervals; forming, for each time interval, a respective number of current mobile terminals for each mobile switching center of the selected mobile switching centers; and forming system loading information from the respective numbers of current mobile terminals for the mobile switching centers over a predetermined number of the time intervals.

### DESCRIPTION OF THE DRAWINGS

Features of exemplary implementations will become apparent from the description, the claims, and the accompanying drawings in which:

FIG. 1 is an embodiment in a telecommunication network according to the present method and apparatus;

FIG. 2 is another embodiment in a telecommunication network according to the present method and apparatus;

FIG. 3 is table depicting an hourly snapshot of the current number of roaming mobile terminals in each mobile switching center of FIG. 2; and

FIG. 4 is flowchart depicting an embodiment according to the present method.

### DETAILED DESCRIPTION

In an embodiment of the present method and apparatus the network may provide a mechanism of taking a snapshot for identifying the number of service-allowed visitor location registers at a designated time. In a further embodiment the network may support taking the snapshot of the number of VLRs at the same designated time across all the mobile switching centers (MSC) in an identified geographic area.

In a cellular system, such as a code division multiple access (CDMA) system, a geographical area is divided into cells, each using some set of frequencies. Each cell corresponds to the area covered by a single transmitter or a small collection of transmitters. The size of each cell is determined by the transmitter's power. Cellular systems are based on the concept of low-power transmitters and relatively small cells, so that the same frequencies can be re-used in non-adjacent cells.

At the center of each cell, there is a base station, consisting of a computer and a transmitter/receiver connected to an antenna, to which all mobile terminals in the cell transmit. Mobile terminals may be, for example, cell phones, car phones, laptop computers, PDAs (personal data assistants), etc. All the base stations are connected to a device known as a mobile switching center (MSC). MSCs are basically end offices in the telephone, system, such as a public switched telephone network (PSTN), and are connected to at least one telephone system end office. MSCs communicate with the base stations, each other, and the PSTN using a packet switching network.

At any given time, each mobile terminal is in a specific cell and under the control of that cell's base station. When the mobile terminal leaves the cell, the base station notices the telephone's signal fading away, and asks the surrounding base stations how much power they are receiving from it. Ownership is then transferred to the cell whose base station is receiving the strongest signal (i.e. where the mobile terminal is now physically located). A signal is sent to the mobile terminal informing it that it is now under the control of a new base station, and it will be asked to switch to a new channel. The whole process is called handoff, and takes approximately 300 milliseconds. Channel assignment is handled by the MSC (the base stations are basically just radio relays).

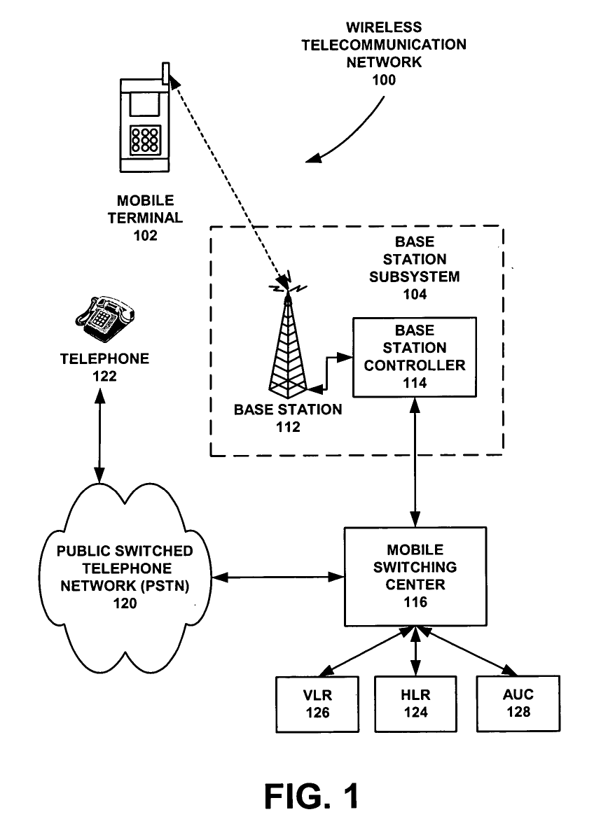

FIG. 1 depicts a wireless telecommunication network 100 that is a CDMA wireless telecommunication network. The entities that form the wireless telecommunication network 100 are defined according to their function and interface requirements. Such a wireless telecommunication network can be divided into several main elements, such as, mobile terminal (MT) 102, base station subsystem (BSS) 104, and mobile switching center (MSC) 116.

The base station subsystem 104 connects the mobile terminal 102 and the mobile switching center 116. The base station subsystem 104 may consist of a base station (BS) 112 and a base station controller (BSC) 114. The base station 112 houses the radio transceivers and antennas used in each cell of the network, and handles the radio link protocols with the mobile terminal 102. It is usually placed in the center of a cell, and its transmitting power defines the size of the cell. Each base station 112 may have, for example, between one and sixteen transceivers, depending on the number of users in the cell. The base station controller 114 may control a group of base stations and manages their radio resources. It is principally in charge of radio channel setup, handoff, frequency hopping, exchange functions and control of the radio frequency power levels of the base stations 112.

The mobile switching center 116 may have a home location register (HLR) 124, a visitor location register 126, and an authentication center (AUC) 128. The mobile switching center 116 may interface with a PSTN 120 for connecting calls to a landline telephone 122, for example.

The home location register 124 may be a database that stores information about subscribers belonging to the area controlled by the MSC 116, including their current location corresponding to the Signalling System Number 7 (SS7) address of visitor location register 126 associated with the mobile terminal 102 when the mobile terminal 102 is roaming, for example. The home location register 124 may also store information about the services to which the mobile terminal 102 may have access.

The visitor location register 126 is utilized when a subscriber enters the coverage area of a new MSC 116. The visitor location register 126 associated with the MSC 116 requests sufficient information about the subscriber from its corresponding home location register that is associated with a home MSC, so that services to the subscriber may be maintained without further reference to the HLR of the home MSC.

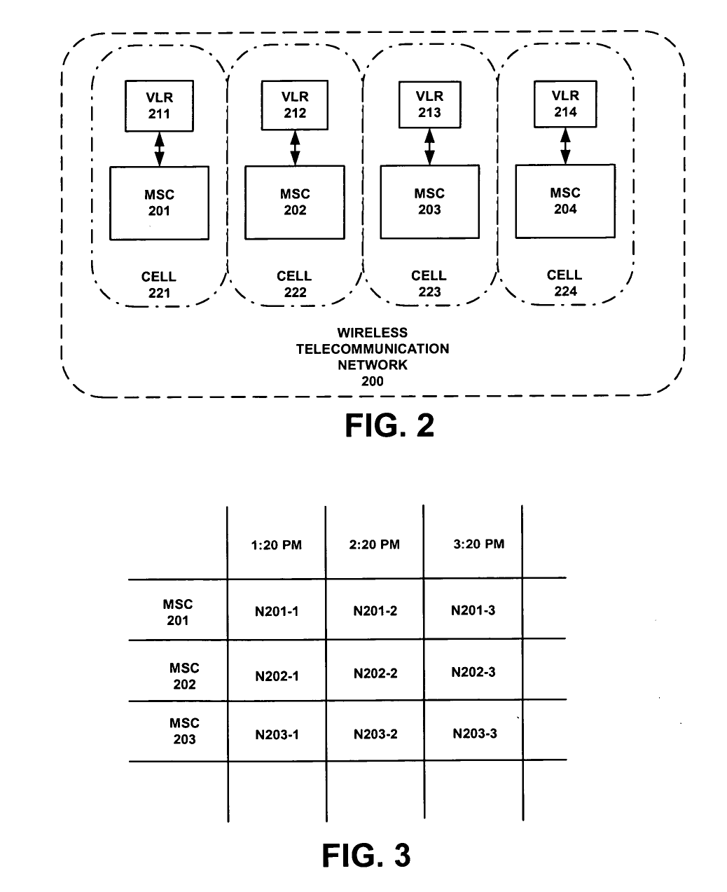

FIG. 2 is another embodiment in a telecommunication network according to the present method and apparatus. A wireless telecommunication system 200 may have, for example, four mobile switching centers 201, 202, 203, 204 with respective visitor location registers 211, 212, 213, 214. Each of the mobile switching centers 201, 202, 203, 204 may have respective associated cell areas 221, 222, 223, 224. Mobil terminals may roam from one cell area to another using handoff procedures as described above.

FIG. 3 is table depicting an hourly snapshot of the current number of roaming mobile terminals in selected mobile switching centers of FIG. 2. For each hourly snapshot there is a current number of roaming mobile terminals N201-1, 2, 3, N202-1, 2, 3 and N203-1, 2, 3. Note that, in this example, only a subset of mobile switching centers MSC 201, MSC 202, MSC 203 is selected from the total number of mobile switching centers MSC 201, MSC 202, MSC 203, MSC 204. The selected set may also include all mobile switching centers.

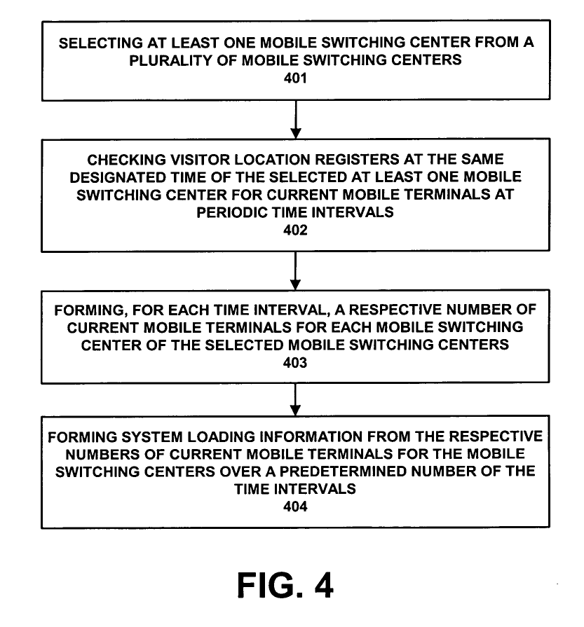

FIG. 4 is flowchart depicting an embodiment according to the present method. An embodiment of the present method may have the steps of: selecting at least one mobile switching center from a plurality of mobile switching centers (401); checking visitor location registers of the selected at least one mobile switching center for current mobile terminals at periodic time intervals (402); forming, for each time interval, a respective number of current mobile terminals for each mobile switching center of the selected mobile switching centers (403); and forming system loading information from the respective numbers of current mobile terminals for the mobile switching centers over a predetermined number of the time intervals (404).

When determining the hardware and software necessary for mobile switching centers, the number of roaming mobile terminals for various mobile switching centers must be determined at various times. The amount and complexity of hardware and software then may be installed based on the estimate traffic volume.

Hardware may be for example the number of channel cards that are to be purchased. Each channel card can only handle a certain amount of traffic. Also, the type of software and the size of databases must be determined based on the estimated traffic volume. Furthermore, using estimated traffic volume, different hardware and software may be added in or subtracted out during different time periods when the traffic volume is estimated to be at different levels.

Thus it is very important to be able to estimate the number of roaming mobile terminals, and especially for different times of the day, week, or other time periods. One embodiment of an estimation is an hourly snapshot of the current number of roaming mobile terminals within the respective area controlled by each mobile switching center in a telecommunication system over a period of a month, for example. Other time periods may be weekly, be-monthly, and even yearly. Also, snapshots may be taken at other intervals such as every two hours, or every 30 minutes. A lower limit may be, for example, 20 minutes since this is a typical time interval when a VLR is cleared of non-active mobile terminals.

As used herein revenue producing roaming mobile terminals may be referred to as major roaming mobile terminals and may include both normal VLR entries and call time VLR entries.

The normal VLR entry ma be representative of a mobile terminal that has registered with the mobile switching center, and for which the mobile switching center has confirmed that the mobile terminal has passed the authorization tests, and has a profile in the present VLR which was received from the home HLR of the roaming mobile terminal. These are VLR entries that are valid or service allowed.

The call time VLR entry refers to the situation wherein a user of a roaming mobile terminal has typed in a number and has pushed“send”, for example. Also, this may refer to when the mobile switching center has started receiving or terminating a call for this mobile terminal. The mobile switching center knows that this is a roaming mobile terminal due to the origination message that is first received from the roaming mobile terminal. Even though a complete record does not yet exist the in the VLR, the mobile switching center is able to identify this mobile terminal as a roamer. The complete record is added into the VLR during the call time. In this classification the mobile terminal also has been authenticated.

Thus, call time VLR entries may be considered normal VLRs that are created through mobile call activities instead of through autonomous registration. Regarding autonomous registration, the mobile terminal periodically sends signals to the mobile switching center to let the mobile switching center know that the mobile terminal is still within the area controlled by the mobile switching center.

In one embodiment of the method a service provider identifies the set of MSCs in the network for which they want to enable the feature. Candidate or selected MSCs are those that have significant roamers consuming system resources at different times of each day, and which pose a problem for the service provider to predict traffic volume.

Once the functionality is enabled on an MSC, the MSC software may take a snapshot at a designated time to calculate the number of service-allowed, that is major, roaming mobile terminals. This is achieved by retrieving the data from the VLR database and only counting the number of non-expired VLRs belonging to the following types as described above: normal VLRs that passed the authentication checks (subscriber profiles are returned from HLR successfully), and call time that VLRs that are normal VLRs created through mobile call activities instead of through autonomous registration.

There are other types of VLRS: no Service, wrong ESN, and virtually deleted. But in one embodiment of the present method and apparatus only the non-expired normal and call time type VLRs may be considered as service-allowed VLRs that are potentially able to receive services from the system. The other types of VLRs are not able to receive any service from the system and need not be considered. Expired VLRs of any type will be rebuilt and determined if they are service-allowed at their next system access. Regarding the plurality of selected MSCs in the system, the system may perform the VLR snapshot for all the selected MSCs at the same designated time. For example, at 20 minutes of each hour the snapshot is performed on all selected MSCs.

The number of roaming mobile terminals obtained by the snapshot mechanism represents the true number of potential mobile users that will consume the MSC resource for the hour because the same mobile user will not appear on two different MSCs' VLR databases at the same time for the same hour.

An Erlang is a unit of telecommunications traffic measurement. Strictly speaking, an Erlang represents the continuous use of one voice path. In practice, it is typically used to describe the total traffic volume for one hour.

For example, if a group of users made 30 calls in one hour, and each call had an average call duration of 5 minutes, then the number of Erlangs this represents is worked out as follows:
Minutes of traffic in the hour=number of calls×duration
Minutes of traffic in the hour=30×5
Minutes of traffic in the hour=150
Hours of traffic in the hour=150/60
Hours of traffic in the hour=2.5
Traffic figure=2.5 Erlangs

Erlang traffic measurements are made in order to help telecommunications network designers understand traffic patterns and system capacity within their voice networks. This is essential if they are to successfully design their network topology and establish the necessary trunk group sizes. Erlang traffic measurements or estimates can be used to work out how many lines are required between a telephone system and a central office (PSTN exchange lines), or between multiple network locations.

In a mobility system, the system capacity for the hour may be defined as the total Traffic System Usage in Erlangs, which is calculated by using the following formula:
Total System Erlangs=(Total 10-second Walsh Code Usage for the hour)/360

where the Walsh Code, also known as “Walsh-Hadamard code”, is an algorithm that generates statistically unique sets of numbers for use in encryption and cellular communications.

With the new parameter introduced by the present embodiments, the per user Erlangs can be calculated by:
Average per user Erlangs=(Total System Erlangs/Total Number of Service-Allowed Subscribers)

The present apparatus in one example may comprise a plurality of components such as one or more of electronic components, hardware components, and computer software components. A number of such components may be combined or divided in the apparatus.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a telecommunications network having a plurality of mobile switching centers each of the mobile switching centers having a respective visitor location register (VLR);
a selected at least one mobile switching center of the plurality of mobile switching centers;
periodic time intervals; and
a respective set of recordings of numbers of current entries in the respective visitor location registers of the selected at least one mobile switching center existing at an end of each of the time intervals.

2. The apparatus according to claim 1, wherein the selected at least one mobile switching center is a mobile switching center having a plurality of roaming mobile terminals that consume system resources.

3. The apparatus according to claim 1, wherein the current entries are non-expired VLR entries belonging to the following types: normal VLRs that passed authentication checks, and call time VLRs that are normal VLRs that are created through mobile call activities instead of through autonomous registration.

4. The apparatus according to claim 1, wherein the respective set of recordings represents respective current numbers of roaming mobile terminals present in cell areas of selected mobile switching centers for each of a plurality of time intervals.

5. The apparatus according to claim 1, wherein selected mobile switching centers are those that have a plurality of roaming mobile terminals consuming system resources at different times of each day.

6. The apparatus according to claim 1, wherein the periodic time interval is hourly.

7. The apparatus according to claim 1, wherein the set of recordings of numbers covers one month.

8. The apparatus according to claim 1, wherein set of recordings is an hourly snapshot performed at a same designated time of the current number of roaming mobile terminals in each mobile switching center of the selected mobile switching centers over a period of a month.

9. An apparatus, comprising:
a telecommunications network having a plurality of mobile switching centers each of the mobile switching centers having a respective visitor location register (VLR);
a subset formed of selected mobile switching centers of the plurality of mobile switching centers;
a set of numbers of roaming mobile terminals associated with each of the selected mobile switching centers taken at periodic time intervals, roaming mobile terminals being represented by visitor location register (VLR) entries; and
system loading represented by the set of numbers of mobile terminals.

10. The apparatus according to claim 9, wherein the selected mobile switching centers are mobile switching centers having pluralities of roaming mobile terminals that consume system resources.

11. The apparatus according to claim 9, wherein the current entries are non-expired VLR entries belonging to the following types: normal VLRs that passed authentication checks, and call time VLRs that are normal VLRs that are created through mobile call activities instead of through autonomous registration.

12. The apparatus according to claim 9, wherein the respective set of numbers represents respective current numbers of roaming mobile terminals present in cell areas of selected mobile switching centers for each of a plurality of time intervals.

13. The apparatus according to claim 9, wherein selected mobile switching centers are those that have a plurality of roaming mobile terminals consuming system resources at different times of each day.

14. The apparatus according to claim 9, wherein the periodic time interval is hourly.

15. The apparatus according to claim 9, wherein the set of numbers covers one month.

16. The apparatus according to claim 9, wherein the set of numbers is an hourly snapshot performed at a same designated time of the current number of roaming mobile terminals in each mobile switching center of the selected mobile switching centers over a period of a month.

17. A method, comprising:
selecting at least one mobile switching center from a plurality of mobile switching centers;
checking visitor location registers (VLR) of the selected at least one mobile switching center for current mobile terminals at periodic time intervals;
forming, for each time interval, a respective number of current mobile terminals for each mobile switching center of the selected mobile switching centers; and
forming system loading information from the respective numbers of current mobile terminals for the mobile switching centers over a predetermined number of the time intervals.

18. The method according to claim 17, wherein the selected mobile switching centers are mobile switching centers having pluralities of roaming mobile terminals that consume system resources.

19. The method according to claim 17, wherein the current entries are non-expired VLR entries belonging to the following types: normal VLRs that passed authentication checks, and call time VLRs that are normal VLRs that are created through mobile call activities instead of through autonomous registration.

20. The method according to claim 17, wherein the respective set of numbers represents respective current numbers of roaming mobile terminals present in cell areas of selected mobile switching centers for each of a plurality of time intervals.

21. The method according to claim 17, wherein selected mobile switching centers are those that have a plurality of roaming mobile terminals consuming system resources at different times of each day.

22. The method according to claim 17, wherein the periodic time interval is hourly.

23. The method according to claim 17, wherein the set of numbers covers one month.

24. The method according to claim 17, wherein the set of numbers is an hourly snapshot performed at a same designated time of the current number of roaming mobile terminals in each mobile switching center of the selected mobile switching centers over a period of a month.
